(19) United States
(12) Patent Application Publication
(10) Pub. No.: US 2004/0260785 A1
(43) Pub. Date: Dec. 23, 2004

(54) Surveillance system via the internet

(76) Inventors: Hoy Leong Kong, Penang (MY); Lau Sze Ming, Penang (MY)

Correspondence Address: BACON & THOMAS, PLLC, 625 SLATERS LANE, FOURTH FLOOR, ALEXANDRIA, VA, 22314

(21) Appl. No.: 10/492,526

(22) PCT Filed: Oct. 23, 2002
(86) PCT No.: PCT/SG02/00247

(30) Foreign Application Priority Data
Oct. 26, 2001 (MY) PI 20014970

(51) Int. Cl. G06F 15/16

(52) U.S. Cl. 709/217

(57) ABSTRACT

The present invention relates to a surveillance system via the internet more particularly one that allows the user flexibility to monitor a predetermined area through a computer linked at any point. A surveillance system via the internet that allows the a client to access from a remote computer the view of a predetermined area via a camera connected to a home computer that is linked to the internet.

### FIELD OF INVENTION

The present invention relates to a surveillance system via the internet more particularly one that allows the user flexibility to monitor a predetermined area through a computer linked at any point.

### BACKGROUND OF THE INVENTION

Presently, in order for a user to monitor to on goings in for example the house, office or so on, using a computer with the internet linkage are as follows:

Fix Internet Protocol (IP) Address Method;

According to this system a user will be able to communicate between two computers via the internet. However, the user has to use a dedicated computer installed with a special program in order to do so.

Therefore the user does not have the freedom to use any computer in any part of the world which is linked to the world wide web to monitor the situation of a predetermined area. Further more, monthly charges is also charged to the subscribers in addition to the monthly rental for the fix IP address from the local ISP (Internet Service Provider).

Moreover the above methods or any other communication via the internet does not allow the user to have access to the IP address of the computer the user would like to communicate with.

Normally, conventional DHCP (dynamic host configuration protocol) processes are capable of assigning a temporary IP address. The said IP address is known as Dynamic IP address and will be assigned by the local ISP (Internet Service Provider). Each time the user login to the internet, the IP address will be different from the previous address. It changes to the computer network address.

When a PC accesses the Internet for the first time, it does not have an Internet address and seeks one by broadcasting a signal and then will be assigned by the local ISP (eg. Jaring or TMNET, AOL, etc). The user will login into the network via the PSTN (Public Switch Telecom Network) by calling a predetermined number eg 1515 (TMNET). Then the local ISP will assign the computer hardware network a temporary IP address i.e. once the user successful login into the internet to enable him to link to the www (world wide web). However it is reiterated that the assigned IP address is only temporary as each time the user login and logout, the IP address will be changed.

Accordingly, temporary IP addresses may be assigned to a user's remote PC by way of connection between a DNS (domain name server) and the DHCP (dynamic host configuration protocol) server. This provides a scheme for mapping the IP address numbers against domain names.

Therefore the present invention aims to overcome the above problems.

The object of the present invention is to provide means to detect IP address of a remote PC. It is more specifically to locate accurately a computer hardware that is connected to the www through the network system (PSTN) with a temporary IP address (Dynamic IP address—that is controlled by the ISP) each time the user logs in/out. This is to allow the user to communication to a remote computer(s) which is already logged on to the www. In order have communication between the said computers) and the computer located accurately by having the dynamic IP address, verification process will be carried out via the server to make sure authorized personnel only will be allowed to access the computer.

It is also an object of the invention to provide means to monitor the on goings of a pre determined area via a computer connected to the world wide web.

### SUMMARY OF THE INVENTION

It has now been provided an improved surveillance system via the net. Thus in accordance with a first embodiment of the invention a method to monitor the on going of a predetermined area by a computer from any part of the world so long as the said computer is linked to the world wide web.

### BRIEF DESCRIPTIONS OF THE INVENTION

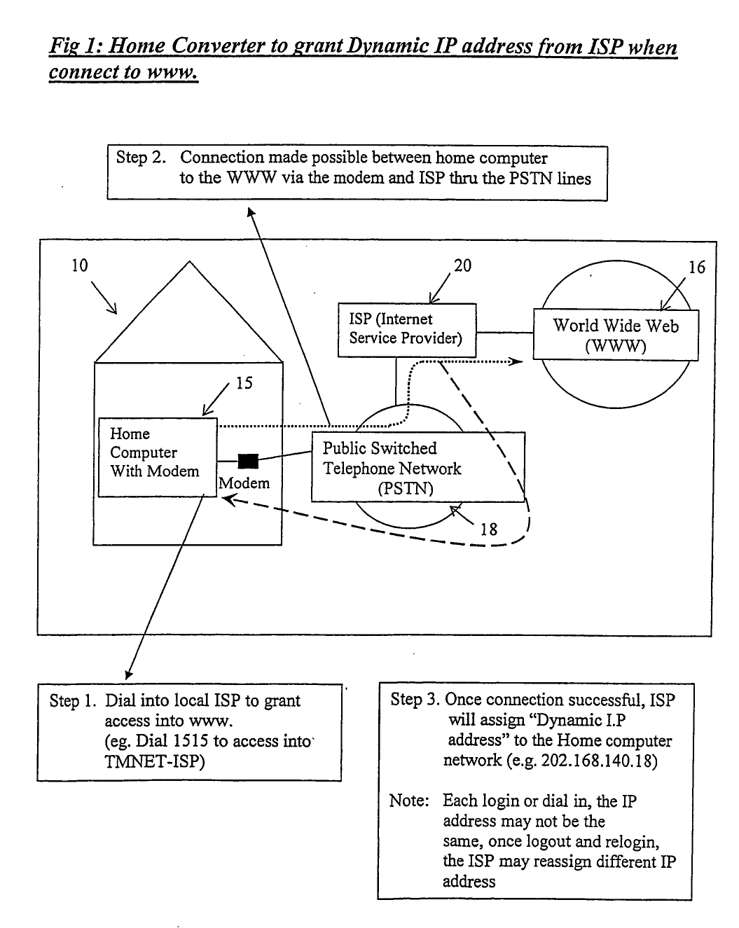

FIG. 1 illustrates the a block diagram of getting Dynamic IP address

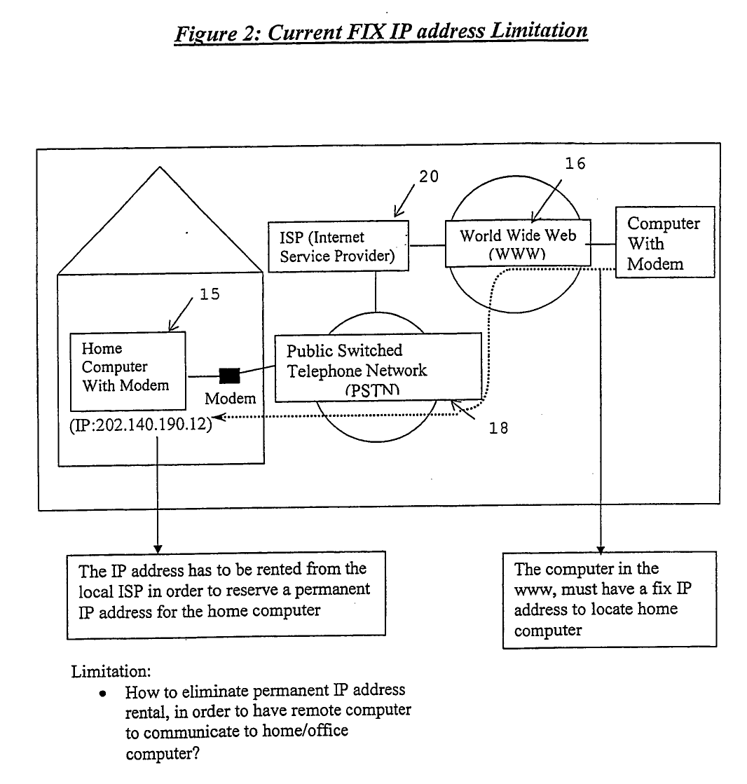

FIG. 2 shows one of the prior art

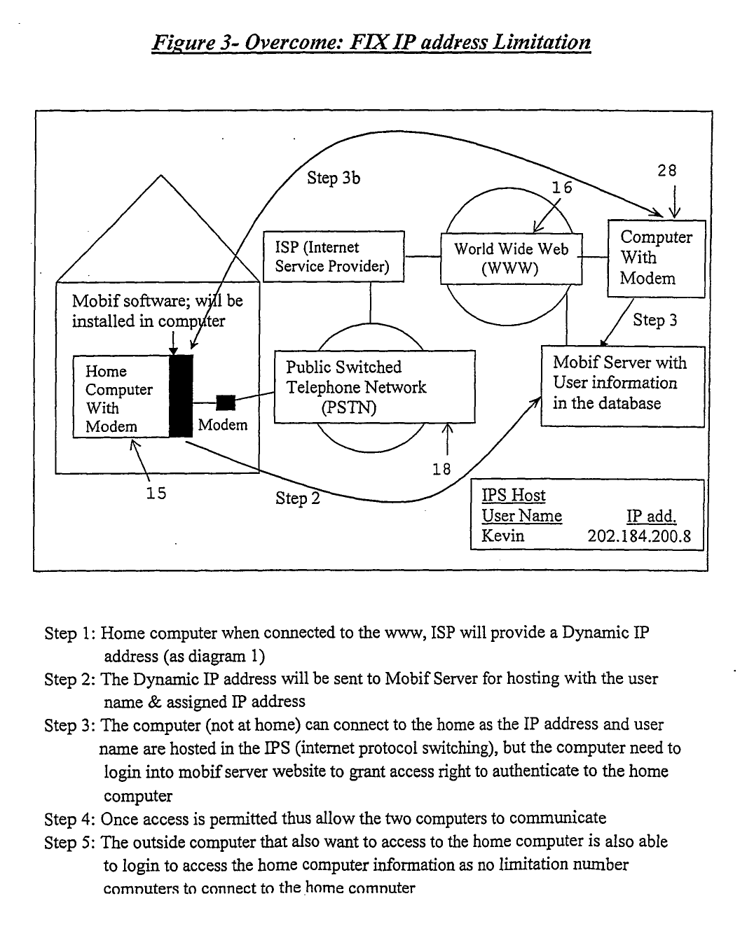

FIG. 3 shows the method to overcome the fix IP address limitation

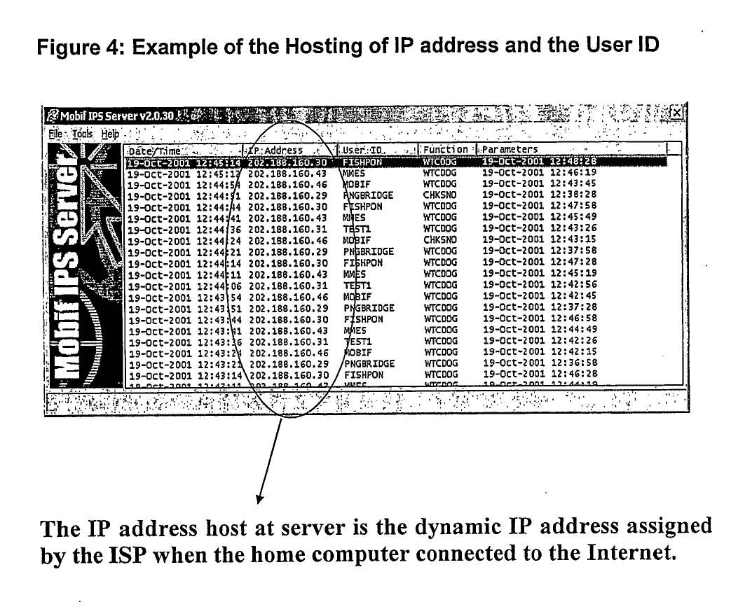

FIG. 4 shows an example of the hosting of the IP address and the user ID

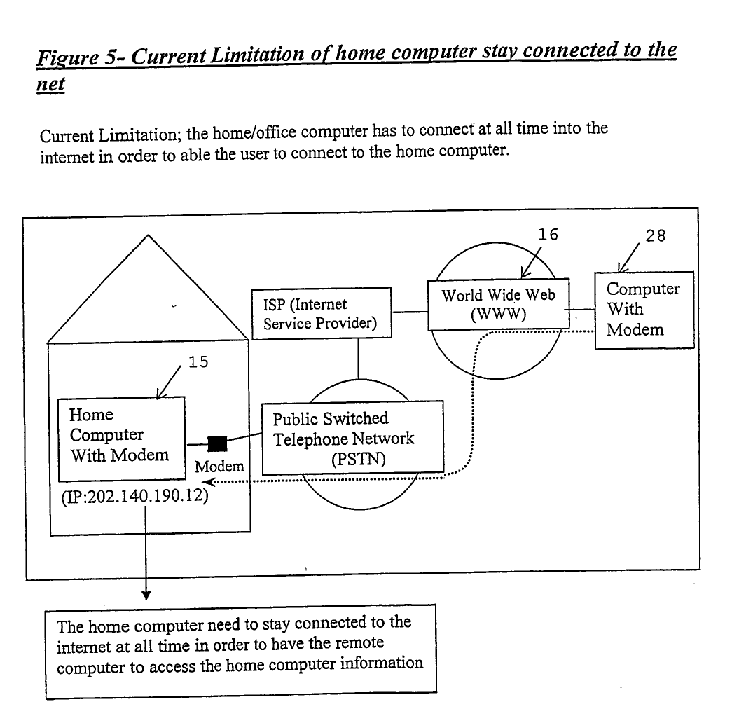

FIG. 5 illustrates how the home computer is connected to the net presently

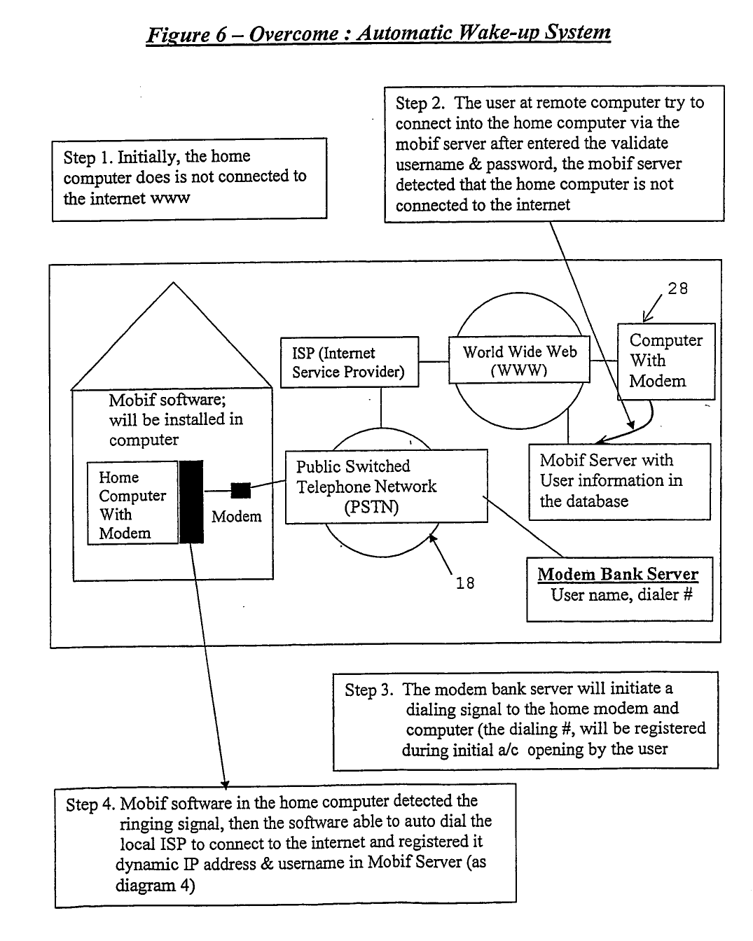

FIG. 6 shows the automatic wake up according to the present invention

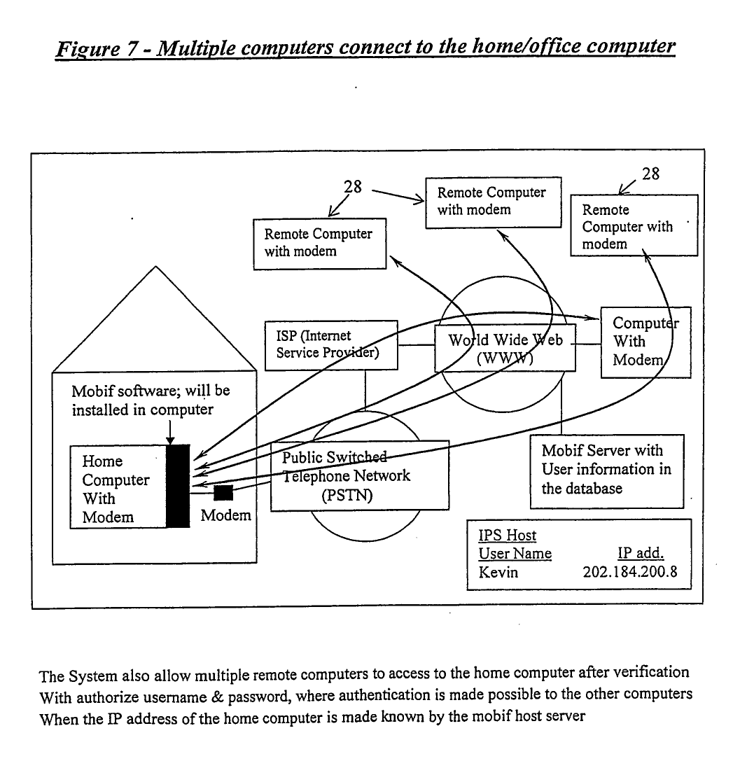

FIG. 7 shows how multiple computers are connected to the home

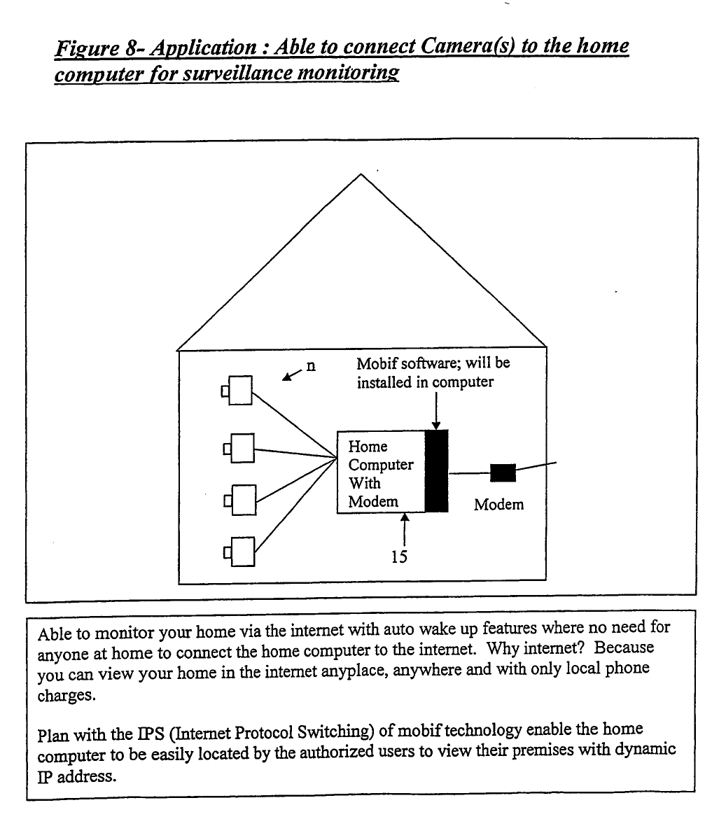

FIG. 8 illustrates the means of connecting cameras to view a predetermined surrounding.

### DETAILED DESCRIPTION OF THE DRAWINGS

To facilitate a complete understanding of the invention, the description of the preferred embodiment is arranged within the following sections:

1. GLOSSARY OF TERMS AND ACRONYMS

2. OVERVIEW OF SYSTEM COMPONENTS AND OPERATION

3. CONCLUSION

1. Glossary of Terms and Acronyms

The following terms and acronyms are used throughout the detailed description:

Client-Server. A model of interaction in a distributed system in which a program at one site sends a request to a program at another site and waits for a response. The requesting program is called the “client,” and the program which responds to the request is called the “server.” In the context of the World Wide Web (discussed below), the client is a “Web browser” (or simply “browser”) which runs on a computer of a user; the program which responds to browser requests by serving Web pages is commonly referred to as a “Web server.”

Internet. A collection of interconnected (public and/or private) networks that are linked together by a set of standard protocols (such as TCP/IP and HTTP) to form a global, distributed network. (While this term is intended to refer to what is now commonly known as the Internet, it is also intended to encompass variations which may be made in the future, including changes and additions to existing standard protocols.)

World Wide Web (“Web”). Used herein to refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

Web Site. A computer system that serves informational content over a network using the standard protocols of the World Wide Web. Typically, a Web site corresponds to a particular Internet domain name, such as “amazon.com,” and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users.

HTML (HyperText Markup Language). A standard coding convention and set of codes for attaching presentation and linking attributes to informational content within documents. (HTML 2.0 is currently the primary standard used for generating Web documents.) During a document authoring stage, the HTML codes (referred to as “tags”) are embedded within the informational content of the document. When the Web document (or HTML document) is subsequently transferred from a Web server to a browser, the codes are interpreted by the browser and used to parse and display the document. Additionally in specifying how the Web browser is to display the document, HTML tags can be used to create links to other Web documents (commonly referred to as “hyperlinks”). For more information on HTML, see Ian S. Graham, The HTML Source Book, John Wiley and Sons, Inc., 1995 (ISBN 0471-11894-4).

HTTP (HyperText Transport Protocol). The standard World Wide Web client-server protocol used for the exchange of information (such as HTML documents, and client requests for such documents) between a browser and a Web server. HTTP includes a number of different types of messages which can be sent from the client to the server to request different types of server actions. For example, a “GET” message, which has the format GET, causes the server to return the document or file located at the specified URL.

URL (Uniform Resource Locator). A unique address which fully specifies the location of a file or other resource on the Internet. The general format of a URL is protocol://machine address:port/path/filename. The port specification is optional, and if none is entered by the user, the browser defaults to the standard port for whatever service is specified as the protocol. For example, if HTTP is specified as the protocol, the browser will use the HTTP default port of 80.

2. Overview of System Components and Operation

FIGS. 1-8 illustrate the general architecture of the system that operates in accordance with the present invention. The system relates to a surveillance system via the internet more particularly one that allows the user flexibility to monitor a predetermined area through a computer linked at any point. The system includes at least one home computer with each computer equipped with a modem, said modem connected to the internet.

The present invention allow a user who has access to a computer that is linked to the internet to get the current IP address of the computer the user would like to view.

According to the flow diagram the typical manner to access the IP address according to the preferred embodiment is as follows; The user or client intending to view the video camera installed in for example the user's house that is linked to the computer in the said house would firstly access a particular predetermined website which will be the official website for this particular system. Once in the website the user would have to key in a valid username and password. This is if the user has already registered before, if not the user will have to register online first. The essential information that is required during registration would be as follows:

a) Name

b) Preferred User Name & Password

c) Address

d) Contact number

e) Dial-out number

f) Country

g) product to purchase

The above are only preferred information needed. Some information maybe deleted or more maybe added which will depend on the server operator.

The above information is mainly used for identifying the client when the client accesses the web page in order to prevent anyone from viewing the camera. It is to be reiterated here that the above are preferred and not essential information.

However, the dial-out number is required to allow the modem bank server to autowake the desired computer and connecting it to the internet thus allowing the client to view through the camera connected to the said computer.

Once the correct username & password are given, then the required “dial-up phone number” is essential to enable the dialer server (modem bank) to initiate a call to the surveillance computer where preferably a camera is connected to view the predetermined surroundings. The above preferred information are store in the “server” database and it is to be noted that it will only allow authorized user with the correct username and password to be able to access into the database and the system will initiate a signal dialing to the given “dial-up phone number” by the modem bank so that when the surveillance computer receives the ringing signal from the modem it will automatically wake up. It will then connect to the internet (www), and also send a signal back to the server together with its location and the assigned Dynamic IP address given by the ISP. The manner in which the IP address is read is beyond the scope of the present invention. Hence, the server is able to host the surveillance computer name and its temporary assigned IP address for that duration of login.

The home computer will receive dialing signal from the modem bank when each time the user login into server, after verification of user name with correct password, then the server will assign (authenticate) the user to the host dynamic IP address where the system will match the surveillance computer to the authorized user in the database server, (provided the surveillance computer is already connected to the internet-www). But if the surveillance computer is still not connected to the internet, then the modem bank will dial the surveillance computer modem bank to make the computer automatically connect to the internet where a software adapter will be installed in the computer. This software adapter will hereinafter be called IP Tracker, that is capable of the following:

a) Track (receiving) the signal send from the server thru ringing tone via the PSTN line

b) Automatically, connect the computer to the local ISP (Internet service provider) that is preset by the users. Eg. i) ISP dialup number, ii) user login name iii) password

c) The tracker will auto dial the computer modem with the preset ISP dialup number (eg. 1515—TMNET, 1511—Jaring)

d) The tracker will then login into the local ISP with the preset login id and password

e) The tracker will also automatically detect the login IP address provided by the local ISP

f) The tracker will send the IP address information of the surveillance computer back to the server to identify that surveillance computer IP address and User ID to enable the user to locate the the surveillance computer in the WWW.

Once, the connection is established between the user and surveillance computer, whereby the communication flow will enable the user to view images captured from the camera connected to the said surveillance computer on the clients computer screen.

The server reads the current IP address of the computer at home. The said IP address which was assigned by the ISP will be sent to the server for hosting by the installed software in the home computer. Once the computer is connect to the internet and while the software is still active, the software will send the dynamic IP address and the computer identity (username) to the server for hosting whereby the user from other place to login into the website, then they able to make connection possible to their home with the correct matching by the system.

Once the IP address is identified then it is sent to the server which in turn sends it to the users computer. And the system will make authentication redirect the user computer to the home computer as the IP address is make known to the user computer to establish the connection.

3. Conclusion

While the invention has been described herein with reference to certain preferred embodiments, these embodiments have been presented by way of example only, and not to limit the scope of the invention.

Accordingly, the scope of the invention should be defined only in accordance with the claims that follow. In the following claims, reference characters used to designate claim steps are provided for convenience of description only, and are not intended to imply any particular order for performing the steps.

1) A surveillance system via the internet that allows the a client to access from a remote computer the view of a predetermined area via a camera connected to a home computer that is linked to the internet.

2) A surveillance system via the internet as claimed in claim 1 wherein the remote computer is connected to the world wide web.

3) A surveillance system via the internet as claimed in claim 1 wherein the user of the remote server has to log into a particular website in order to access the IP address of the home computer in order to link to it in order to view the camera linked to the said home computer.
